(19) United States
(12) Patent Application Publication
(10) Pub. No.: US 2018/0082337 A1
(43) Pub. Date: Mar. 22, 2018

(54) REVENUE SHARING AND REPORTING SYSTEM

(71) Applicant: Michael Shapiro, NEW PROVIDENCE, NJ (US)

(72) Inventor: Michael Shapiro, NEW PROVIDENCE, NJ (US)

(21) Appl. No.: 15/710,264

(22) Filed: Sep. 20, 2017

Related U.S. Application Data
(60) Provisional application No. 62/396,884, filed on Sep. 20, 2016.

(51) Int. Cl. G06Q 30/02; G06Q 20/40

(52) U.S. Cl. CPC G06Q 30/0274; G06Q 20/407; G06Q 30/0261

(57) ABSTRACT

The present disclosure provides revenue sharing reporting systems. In some instances, the revenue sharing may be split between multiple entities to allow for a payment distribution platform. The present system may also allow for the issuing of refunds, deductions, and other calculations to be performed. Such calculations are performed and, in some instances, split amongst various entities according to system defined parameters.

### CLAIM OF PRIORITY

This non-provisional application claims priority to U.S. provisional application 62/396,884 filed on Sep. 20, 2016, the contents of which is fully incorporated by reference in its entirety.

### FIELD OF THE EMBODIMENTS

The field of the embodiments of the present invention relate to revenue sharing and or splitting models. In particular, the revenue sharing may be split between multiple entities to allow for a payment distribution platform.

### BACKGROUND OF THE EMBODIMENTS

Websites, and more generally the Internet, are used to disseminate information and to form public opinion about a variety of topics. The ubiquitous nature of the twenty four hour news cycle and proliferation of “smart” devices has made current events more accessible than ever. Consumer or readers of a particular website can frequently provide comments in an interactive manner with other consumers.

Readers have an often overwhelming array of sources from which to get desired information. A number of techniques have been proposed or suggested to allow online users to more effectively identify information of interest. For example, there are a number of web sites available that aggregate certain types of information from multiple online sources. For example, a news aggregator aggregates news from multiple news sources. Increasingly, such aggregator web sites incorporate content from one or more blogs or freelance submissions.

The growing popularity of such news or content aggregating sites has the potential to generate copious amounts of money. However, managing and reporting that money or revenue in an orderly fashion has proven difficult. In addition, it is difficult for one to determine who is to be paid for what content. Further, systems are need to provide shared revenues to multiple sources to encourage content to be provided across the platform. A need therefore exists for methods and apparatus for such a revenue and reporting system for franchisers and franchisees within a business. The present invention and its embodiments meets and exceeds these objectives.

### Review of Related Technology:

U.S. Pat. No. 8,145,526 pertains to a computer-based method and system which shares revenue with a content provider and registered users. A web page has supplied electronic content and ads with displays and hyperlinks to a corresponding advertiser designated web site. Associated sales referral fees are tracked based upon user click throughs. The content provider is incentivized because the system shares the associated sales referral fees with him based upon factors such as frequency of posting content, quality rankings by users, gross value referral fees, and page user-visitors. Registered user-visitors are incentivized by providing each with N quality ranking tokens and by sharing the referral fees with users who post tokens on content. The QA ranking formula accounts for the quantity of posted tokens, the sequential order of posting, the number of user-visitors, and the referral fee to the content provider. The fees are paid to debit card, credit card, or cell phone account payment processors.

U.S. Pat. No. 7,987,139 pertains to a method for compensating all parties involved in producing the income stream for a content distributor is presented where the content-hosting site, the content writer and the user doing the interaction with paid contents receive a fair share of the generated income stream.

U.S. Patent Application 2016/0019606 pertains to methods and apparatus are provided for the dynamic placement, management and monitoring of Internet advertising. A provider of Internet content distributes the Internet content by embedding an advertisement placeholder in the Internet content; and provides the Internet content to an aggregator web site. The aggregator web site presents the Internet content to at least one end user with at least one advertisement in the advertisement placeholder. The advertisement placeholder is processed by a third party agent to automatically share revenue from the at least one advertisement with the provider of the Internet content and a provider of the aggregator web site. The advertisement placeholder can optionally be embedded in the Internet content using one or more templates. The third party agent also evaluates the content and at least one policy of multiple parties to identify at least one advertisement to present in the advertisement placeholder. The advertisement placeholder embodies a three party agreement between the provider of the Internet content, the provider of the aggregator web site and at least one advertiser.

U.S. Patent Application 2013/0132201 pertains to a bid for a content slot from a content provider. The bid includes a revenue-sharing bid. It is determined that the bid is a winning bid and content is presented from the content provider in the content slot. Presentation details are logged that include a time when the content was presented. At a later time, an indication is received of an action, the indication including an indication that the action is responsive to the content having been presented previously. Based on the action, the content provider is charged an appropriate amount based on the revenue sharing bid.

### SUMMARY OF THE EMBODIMENTS

Generally, the present invention and its embodiments provide for a reporting system that enables one to calculate payments for distribution to business partners and other associated entities. As opposed to typical revenue sharing models (e.g. 50/50 revenue split) the current system allows for splits in revenue to occur up to 5× and in some embodiments up to 7× or more. Each split may be a different percentage and may be based on certain parameters within the system. Further, the reporting system may allow for deductions and refunds to occur.

In some embodiments the reporting system may be integrated with the billing system (pre-existing) thereby enabling the host system to conduct the split and payment reporting. For example, a real estate posting may be listed through a content provider or host system and the money generated by posting the listing is shared with the respective locales where the listing is targeted. Further implementations allow for cloning of content by various related content providers with the ability for each provider to modify the content as need be without affecting the other provider's content.

In one embodiment of the present invention there is a computer implemented method of reporting, the method comprising the steps of: receiving, via a processor, content to be displayed from at least one user; the at least one user selecting a publication range of the content, wherein the publication range is defined geographically, and wherein the publication range is further defined by monetary constraints; presenting, via a processor, the content to the publication range; receiving, from the at least one user, payment relating to the content; sharing the payment between at least two content providers, wherein the sharing is split between geographic locales within the publication range.

In another embodiment of the present invention there is a reporting system comprising: a computing device having a display, wherein the computing device has at least a processor and a memory, the memory being communicatively coupled to the processor and the memory storing computer readable instructions that when executed by the processor cause the processor to perform the steps of: receiving, via a processor, content to be displayed from at least one user; the at least one user selecting a publication range of the content, wherein the publication range is defined geographically, and wherein the publication range is further defined by monetary constraints; presenting, via a processor, the content to the publication range; receiving, from the at least one user, payment relating to the content; sharing the payment between at least two content providers, wherein the sharing is split between geographic locales within the publication range.

In yet another embodiment of the present invention there is a computer program embodied in a non-transitory computer-readable medium comprising computer readable instructions, which when executed by a processor, cause the processor to perform a method reporting comprising the steps of: receiving, via a processor, content to be displayed from at least one user; the at least one user selecting a publication range of the content, wherein the publication range is defined geographically, and wherein the publication range is further defined by monetary constraints; presenting, via a processor, the content to the publication range; receiving, from the at least one user, payment relating to the content; sharing the payment between at least two content providers, wherein the sharing is split between geographic locales within the publication range.

In general, the present invention succeeds in conferring the following, and others not mentioned, benefits and objectives.

It is an object of the present invention to provide a system that allows reporting of revenues generated within a business.

It is an object of the present invention to provide a system enables refunds and deductions to be credited or debited to an account.

It is an object of the present invention to provide a system allows for customized sharing or splitting of revenues.

It is an object of the present invention to provide a system that enables reporting of multi-entity transactions.

It is an object of the present invention to provide a system that provides a platform for content cloning independent of another platform.

### BRIEF DESCRIPTION OF THE DRAWINGS

FIG. 1 is a diagram of a first embodiment of the present invention.

FIG. 2 is a diagram of a second embodiment of the present invention.

FIG. 3 is an exemplary screen showing an invoice screen of the present invention.

FIG. 4 is an exemplary screen showing an advertisement screen of the present invention.

### Description of the Preferred Embodiments

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

### Systems, Devices and Operating Systems

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations.

These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations.

These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.”

The term “client” as used herein refers generally to a computer, program, other device, user and/or combination thereof that is capable of processing and making requests and obtaining and processing any responses from servers across a communications network.

A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

### Computer Systemization

A computer systemization may comprise a clock, central processing unit “CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc.

Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O.

In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like.

The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system.

Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc.

The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s).

The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention.

A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

### Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

### Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., distributed embodiments of the present inveniton), architectures may similarly be employed to pool, load balance, and/or otherwise increase the communicative bandwidth required by the controller of the present invention.

A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like.

One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices, such as other components of the system, including temperature sensors and the like may be connected and/or communicate to I/O and/or other facilities of the like such as network interfaces, storage interfaces, directly to the interface bus, system bus, the CPU, and/or the like. Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions.

Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation.

In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

### Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like.

The operating system may be one specifically optimized to be run on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like.

The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

### Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like.

The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like.

The information server may provide results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces.

Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component is a stored program component that is executed by a CPU. The Web browser may be a conventional hypertext viewing application such as Microsoft Internet Explorer or Netscape Navigator. Secure Web browsing may be supplied with 128bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices.

A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

### Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invnetion.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like.

The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RCS), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like.

Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### A Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

### EMBODIMENTS OF THE PRESENT INVENTION

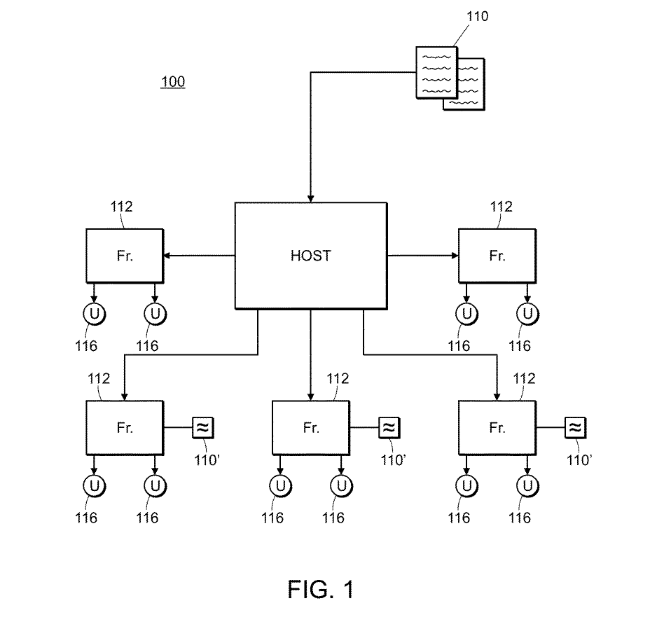

Referring now to FIG. 1, there is a diagram illustrating one embodiment of the present invention. The embodiments of the present invention may generally be run on systems as described above herein. Various components or combinations of components may be employed to create a comprehensive overall system.

Generally, the system 100 comprises content 110, a host or franchisor 114, a subsidiary or franchisee 112, users 116, and derivative content 110′. At least one user may submit content 110 to the host 114 for dissemination of the content 110 to the franchisees 112. The at least one user may be an individual, business, government entity, legal representative, proxy, or the like or some combination thereof.

The content 110 may then be viewed by the users 116. The content 110 may include articles, photos, event listing, classified listings, real estate listings, business listings, email blasts, blogs, opinion work, music, videos, polls, and the like or any combination thereof. The content 110 may be created by the person submitting the content 110 or may be submitted on behalf of a third party.

As the content 110 is pushed to the franchisee 112 from the host 114, the content 110 may be modified into the derivative content 110′. The derivative content 110′ may enable each franchisee 112 to edit, publish, delete, or otherwise modify the content 110 or its status with the franchisee 112 irrespective of the treatment provided by another franchisee 112. However, it must be noted that the franchisee 112 may have flexibility in terms of what content 110 is submitted. In some embodiments, the franchisee 112 can view the content 110 in a pending or holding stage. The franchisee 112 can then select to reject, accept, or send a question/comment to the requester (at least one user) regarding the content 110.

For example, a user submits content 110 to a host 114 which can then disseminate the content 110 to a variety of franchisees 112 or selected franchisees 112 (as selected by the at least one user). The franchisees 112 can then, singularly, modify the content 110 to form derivative content 110′ to conform to system parameters or user preferences. This modified content or derivative content 110′ may then be further shared between entities or franchisees or shared to third parties such as social media sites including Facebook® and Twitter®. In at least one embodiment there is a denotation if the content 110 has been modified into derivative content 110′.

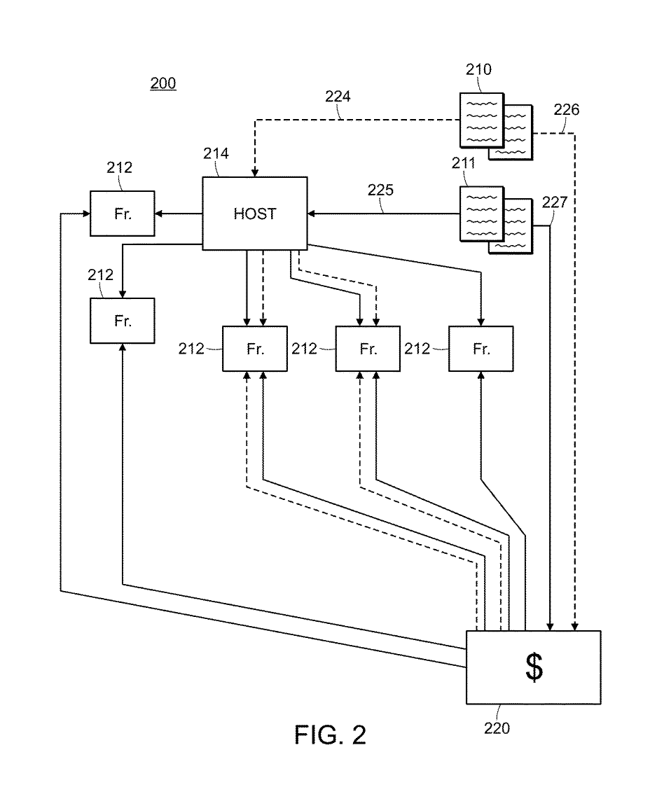

In another embodiment of the present invention, as shown in FIG. 2, there is a system 200. The system generally comprises content 210, a host 214, franchisees 212, and a payment engine 220.

Here, the at least one user submits content 210 to be published or pushed to the host 214. However, the user, in this instance, must pay for the content 210 to be published or pushed 224 to the respective locale. The payment 226 is sent to the payment engine 220. The payment engine 220 then divides the payment into various amount or splits to be shared between the franchisees 212 dependent on the parameters set forth in the system as well as a desired geographic locale for the content 210 to be pushed. In this instance, the payment engine 220 has split the revenue from the content 210 to two of the franchisees 212 as denoted by the dashed lines.

In another instance, content 211 is desired to be entered by the at least one user and proper payment 227 is made. The content is pushed 225 to the host 214. The payment engine 220 then calculates the payment split to be made and calculates that each of the five franchisees 212 shown in FIG. 2 receive some portion of the revenue generated by the content 211.

For example, each of the franchisees 212 may receive equal amounts (assuming an amount is received) of the revenue generated from the content 210, 211. However, each of the franchisees 212 may also receive differing amounts of the revenue. In some embodiments, the revenue received is based proportionally on the number (ave.) of individuals visiting the franchisees 212 over a given time frame. In another embodiment, the revenue is calculated based on the location of the franchisee 212.

Further, such a revenue splitting or sharing system 200 may be tied with the host's billing systems. For example, a user decides to submit content to a classifieds or posting area of the franchisees 212. The user can select the number or location of the franchisees 212 and then submit their payment which goes to the payment engine 220. The payment can then be reported by the billing system and split out according to the percentages selected by the host 214.

To facilitate the interaction between the host 214 and franchisees 212, there is an interactive dashboard which the respective entity can use to discern the monies owed to them and other monetary variables. In some instances, the franchisees 212 can see the revenues come in real time. In other embodiments, the revenues are held for a certain amount of time until the payment is cleared to the franchisee 212 by the host 214. The overall methodology and number of splits between franchisees 212 and their partners may vary but in embodiments of the present invention it is contemplated that the revenues may be split from about 2 to about 25 different ways (between # of entities). In a preferred embodiment, the revenue can be split up to five different ways. For example, the revenue is split amongst five different franchisees.

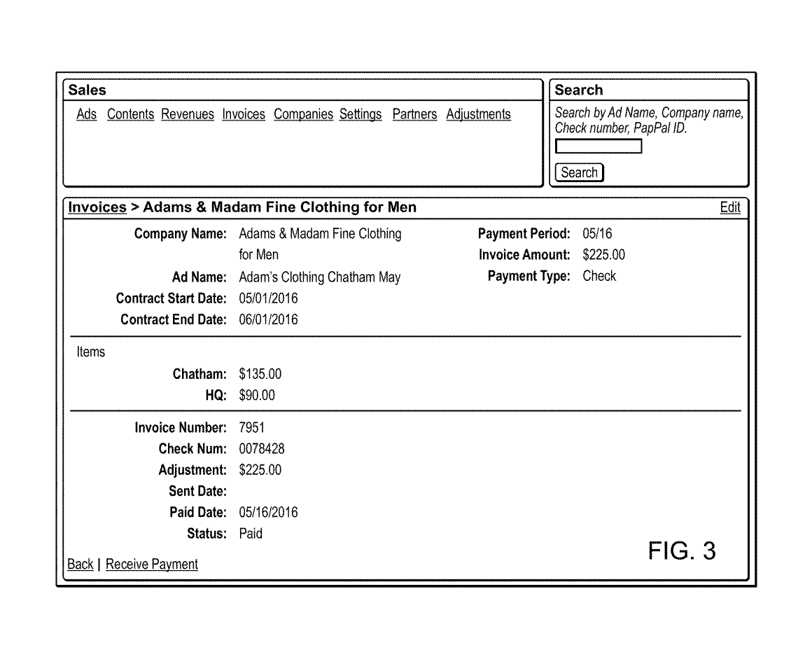

Referring now to FIG. 3, there is an example invoice screen from an embodiment of the present invention. Here, a franchisee, as described in FIGS. 1 and 2 can view various invoices received for advertisements, bulletins, blogs, articles, and the like submitted to their particular franchise for publication. Shown here is the company that makes the purchase and the type of purchase made. In this example, “Adams & Madam Fine Clothing For Men” made an advertisement purchase for a particular franchise that is to run from May 1 to June 1. The ad placer paid $225.00 for the placement. In this instance, the split was 60:40 with 60% going to the franchisee and 40% going to the host or franchisor. As described, various other split ratios and numbers of splits can occur other than the split specifically shown in this instance. Further information to be displayed to the franchisee includes method of payment, when payment was made, transaction numbers, etc.

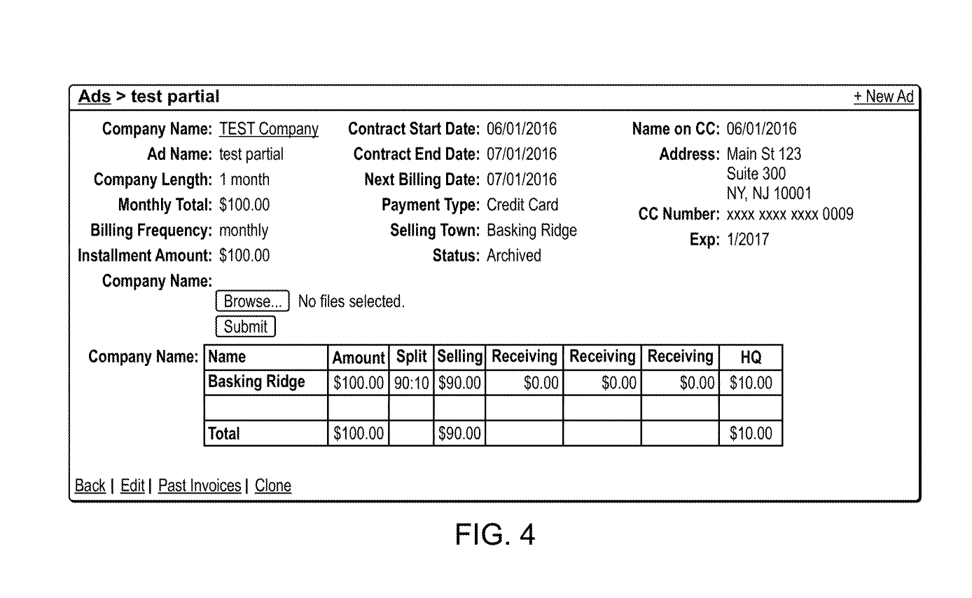

FIG. 4 shows a related screen that details more information pertaining to a particular listing. Here, the particular franchisee can view further terms of the particular content being placed. Listed on are the company name, the content or advertisement name, the contract length, the monthly fee, billing frequency, contract start date, contract end date, payment type, franchisee to which the content is directed, status of content, as well as payment information for automated processing of recurring payments (if needed). Such information is supplied to the franchisee for record keeping purposes as well as management over the content submitted by at least one user.

Further, this screen shows the revenue split or sharing that occurs between the franchisor and the various other entities (franchisees, partners, etc.) Here, the amount of the contract is 1 month with a $100 monthly payment being required for submittal and publication of the content. In the table outlining the revenue sharing attributable to the content, there is an amount column, split column, selling column, receiving columns, and an HQ column.

As shown, the split occurs between HQ or the franchisor and the franchisee. The franchisee receives 90% of the revenue according to the 90:10 split column. The remaining 10% goes to the franchisor. The other receiving columns are blank or zeroed due to there being no further split of the revenue. However, if other splits were to occur based on the publication and dissemination of the content and the relationships between various franchisees, partners, and franchisors, such splits would be located in these columns.

Further, the splits may be modified by either of the franchisee or the franchisor. In another non-limiting example, the transaction is split between a variety of content providers, sales members, etc. In such a scenario the split may be between about 3-10 times and more preferably about 5-7 times. In such a scenario, a single transaction for a real estate listing may be made. This single transaction is processed by the system as a single transaction and then split amongst the designated recipients.

In the real estate example, assuming there is a 5-way split, the split could resemble the following: 60% to franchisee owning the listing, 10% to host, 10% to national sales representative representing franchisee, 10% to regional sales representative representing franchisee, and 10% to local sales representative. Such a split is intended to be illustrative only and the members involved and the percentages to each member may vary. However, the system calculates these splits and distributes the revenue regardless of the split parameters.

In some other embodiments, one needs an administrator or top level access in order to modify the splits for the revenues. In some embodiments, this means the franchisor is the only entity capable of making such changes. Virtually any split in revenue between any number of parties can occur with the caveat that the splits equal 100% of total revenue. Fractional splits, e.g. 45.5%, are also possible within the system as contemplated.

When viewing their overall revenues, the franchisee also has tools that enable them to verify payments received and flag questionable transactions for further verification. Thus, the franchisee can accept or reject a particular payment, at which time a review process can occur between the franchisee and the host or franchisor. The review process may allow for various credits, deductions, or refunds to be made to either of the franchisee or franchisor.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A computer implemented method of reporting, the method comprising the steps of:
receiving, via a processor, content to be displayed from at least one user;
the at least one user selecting a publication range of the content,
wherein the publication range is defined geographically, and
wherein the publication range is further defined by monetary constraints;
presenting, via a processor, the content to the publication range;
receiving, from the at least one user, payment relating to the content; and
sharing the payment between at least two content providers,
wherein the sharing is split between geographic locales within the publication range.

2. The method of claim 1 further comprising the step of:
sharing the content, via a processor, between at least two entities,
wherein the content may be modified by each of the at least two entities irrespective of actions of the other.

3. The method of claim 1 wherein the sharing allows for equal portions to be shared between the at least two content providers.

4. The method of claim 1 wherein the sharing allows for unequal portions to be shared between the at least two content providers.

5. The method of claim 1 wherein the sharing between the at least two content providers equals 100% of the payment.

6. The method of claim 1 further comprising the step of:
issuing at least one refund to one of the at least two content providers.

7. A reporting system comprising:
a computing device having a display,
wherein the computing device has at least a processor and a memory, the memory being communicatively coupled to the processor and the memory storing computer readable instructions that when executed by the processor cause the processor to perform the steps of:
receiving, via a processor, content to be displayed from at least one user;
the at least one user selecting a publication range of the content,
wherein the publication range is defined geographically, and
wherein the publication range is further defined by monetary constraints;
presenting, via a processor, the content to the publication range;
receiving, from the at least one user, payment relating to the content; and
sharing the payment between at least two content providers,
wherein the sharing is split between geographic locales within the publication range.

8. The method of claim 7 further comprising the step of:
sharing the content, via a processor, between at least two entities,
wherein the content may be modified by each of the at least two entities irrespective of actions of the other.

9. The method of claim 7 wherein the sharing allows for equal portions or unequal to be shared between the at least two content providers.

10. The method of claim 7 wherein the sharing is split between at least five content providers.

11. The method of claim 7 further comprising the step of:
issuing at least one refund or a deduction to one of the at least two content providers.

12. The method of claim 11 where in the refund or the deduction is for the content provided by the at least one user.

13. A computer program embodied in a non-transitory computer-readable medium comprising computer readable instructions, which when executed by a processor, cause the processor to perform a method reporting comprising the steps of:
receiving, via a processor, content to be displayed from at least one user;
the at least one user selecting a publication range of the content,
wherein the publication range is defined geographically, and
wherein the publication range is further defined by monetary constraints;
presenting, via a processor, the content to the publication range;
receiving, from the at least one user, payment relating to the content; and
sharing the payment between at least two content providers,
wherein the sharing is split between geographic locales within the publication range.
